(19) United States
(12) Patent Application Publication
(10) Pub. No.: US 2016/0329705 A1
(43) Pub. Date: Nov. 10, 2016

(54) Modular and reconfigurable electrical power conversion device

(71) Applicant: THALES, NEUILLY-SUR-SEINE (FR)

(72) Inventors: Frederic LACAUX, CHATOU (FR); Christophe BRUZY, CHATOU (FR); Jacques CASUTT, CHATOU (FR)

(21) Appl. No.: 14/574,852

(22) Filed: Dec. 18, 2014

(30) Foreign Application Priority Data
Dec. 18, 2013 (FR) 1302974

(51) Int. Cl. H02J 1/00; B64D 47/00; H02M 1/44; H02M 7/68; H02M 1/08

(52) U.S. Cl. CPC H02J 1/00; H02M 7/68; H02M 1/083; H02M 1/44; B64D 47/00

(57) ABSTRACT

A device for powering a plurality of loads from an electrical energy supply network, comprises a number of converters, supplied with electrical energy by the network, ensuring the conversion and the supply of electrical energy for at least one load. The device comprises a control member making it possible to associate a number of converters in parallel to power at least one load, in response to a power requirement from the at least one load. Each of the converters comprises distributed means for limiting recirculation currents generated by the parallel association of a number of converters.

The invention relates to a modular and reconfigurable device for powering a plurality of loads from an electrical energy supply network. More specifically, it relates to an electrical power supply device for aircraft capable of limiting the recirculation currents generated when converters dedicated to powering a same load are connected in parallel.

Large carrier aeroplanes are incorporating increasingly more embedded electrical equipment items. These equipment items are of very varied nature and their energy consumption is highly variable over time. As an example, the aircraft flight controls, the internal air conditioning and lighting systems are operating almost continuously whereas the engine start systems, the electric braking systems, or even the redundant safety systems such as the control surface controls, are used only for short periods during a mission.

Generally, the aircraft has a three-phase electrical energy supply network making it possible to power all of the electrical equipment items, hereinafter called loads. The various loads may require different energy inputs in terms of voltage and in terms of current type, alternating or continuous. Moreover, the loads may be more or less tolerant to the disturbances of the electrical network which powers them. In most of the electrical power supply systems that are embedded these days on aircraft, each load has its own converter and its dedicated filtering network associated with it. Attempts have been made to implement a more modular electrical power supply structure, making it possible to dynamically allocate one or more converters to electrical loads according to the power requirements thereof. The patent application published under the reference FR0603002, describing the principle of a modular electrical power supply device, is in particular known from the applicant. FIG. 1 of this application illustrates the principle of such a modular electrical architecture. An electrical energy supply network 10 comprises, for example, a number of electrical generators 11 on board the aircraft. The network may also comprise electrical energy storage batteries. It may also comprise means for connecting to an electrical power supply network on the ground, making it possible to supply electrical power to the aircraft parked on a runway. The electrical energy supply network 10 comprises conversion means 12 and filtering means 13 making it possible to implement the electrical signal generated by the generators 11 and transmitted to the onboard network. This electrical energy supply network 10 makes it possible to power a plurality of loads 14. They can be air conditioning systems ECS, ECS standing for Environmental Control Systems, engine start systems MES, MES standing for Main Engine Start, or hydraulic pumps EMP, EMP standing for Electro Mechanical Pump, implemented for example to control flight control surfaces.

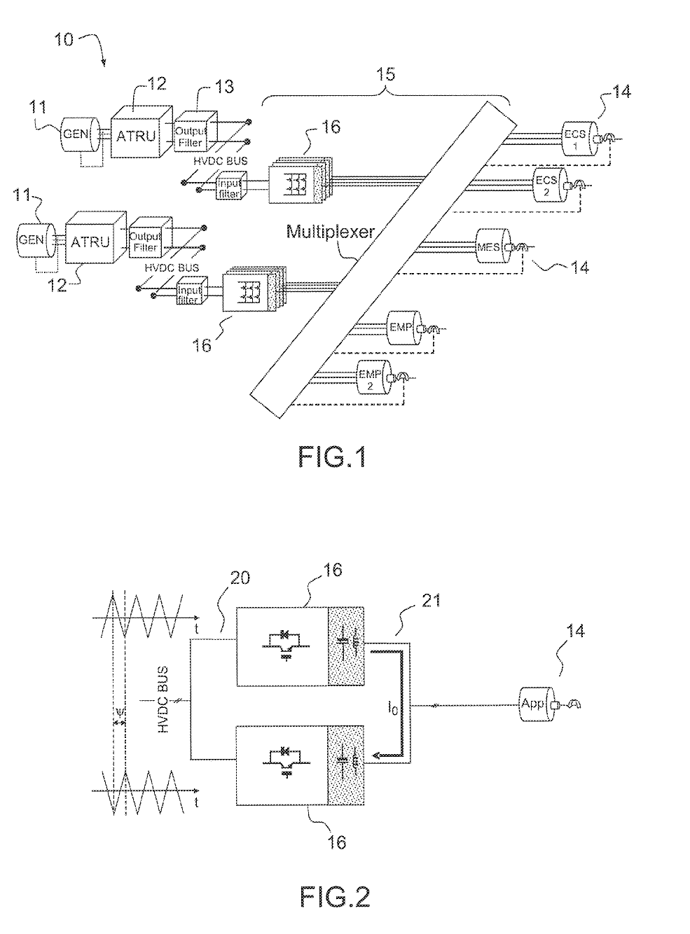

Between the electrical energy supply network 10 and the plurality of loads 14, the purpose of a modular power supply device 15 is to allocate in real time, to each load, one or more converters 16 according to the power requirements of the load. Combining a number of converters 16 in parallel is envisaged, making it possible to supply the necessary power level to a load 14. The parallel connection of converters 16, by a real time allocation driven by a control member, to the plurality of loads 14, makes it possible to optimize the embedded conversion power and therefore limit the weight and the cost of the conversion elements. To reduce the electrical noise and be capable of observing the EMI requirements, EMI standing for Electro Magnetic Interference, techniques of filtering and of interleaving of the parallel-associated converters are applied. The interleaving of the signals from two converters in parallel is illustrated in FIG. 2. The filtering incorporated in the converters is optimized by the real-time interleaving both at the input 20 of the converters 16, on the side of the electrical energy supply network 10, and at the output 21 of the converters 16, on the side of the electrical load 14. The switching frequency and the duty cycle opening control, or PWM, can also be adapted in real time to optimize the size and the weight of the filters.

The implementation of a modular and reconfigurable electrical power supply device therefore relies on the capacity to parallel-connect and interleave a number of converters dynamically. The parallel connection and/or the interleaving does however face difficulties linked notably to the generation of recirculation currents between the converters. These recirculation currents significantly increase the total current seen by the active components of the converters. To withstand these high currents, a significant overdimensioning of the components becomes necessary. Adapting the converters to the recirculation currents through an appropriate dimensioning of the active components (in thermal, electrical, EMI terms) is in practice unrealistic, the weight, the volume and the cost of such a converter being inappropriate.

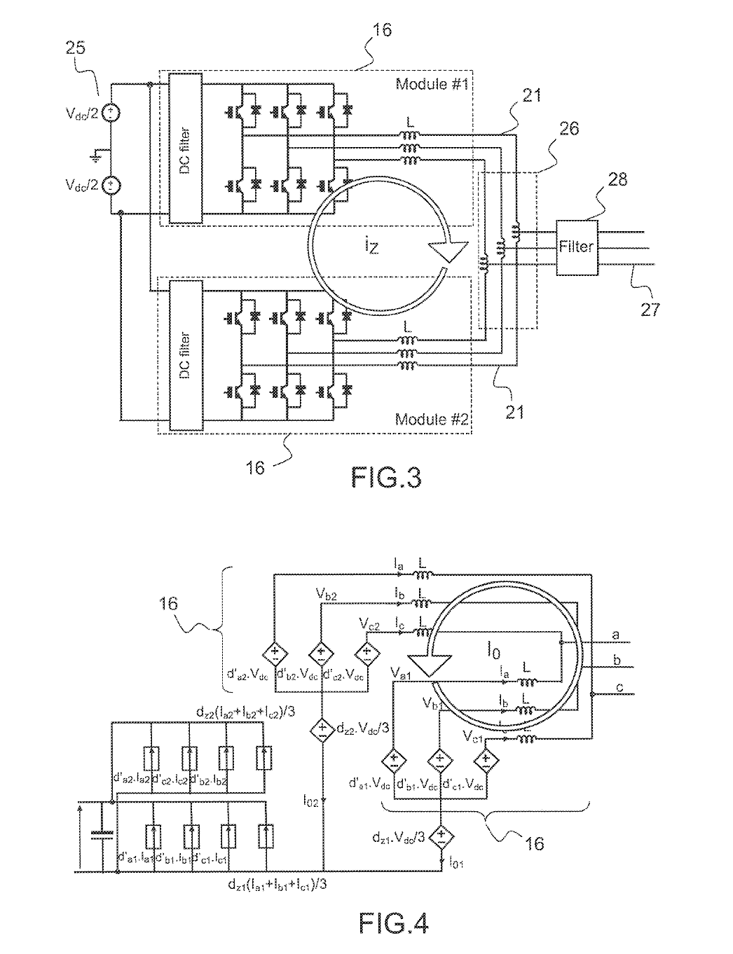

To overcome the difficulties raised by the generation of recirculation currents, one solution that is envisaged consists in implementing, between the parallel-associated converters, an interphase inductor, also called interphase induction coil. FIG. 3 illustrates the principle of the use of an interphase induction coil for the parallel combination of two converters. In this example, two converters 16 are supplied in parallel by a same electrical source 25. The outputs 21 of the two converters 16 are linked to an interphase induction coil 26. The interphase induction coil 26 assembles the signals from the outputs 21 of the converters 16 into an output signal 27. The parallel association of two converters 16 generates recirculation currents represented and referenced i_{z} in FIG. 3. The interphase induction coil 26 is used to generate a significant zero-sequence impedance making it possible to reduce the recirculation currents, in particular the high-frequency recirculation currents. This solution consists in connecting one by one each of the three phases of the two converters by means of an interphase induction coil. This solution makes it possible to effectively limit the recirculation currents, but its major drawback is the addition of an element between the converters. For a complex electrical power supply architecture, implementing a large number of sources and of electrical loads, it is necessary to add as many interphase induction coils as there are envisaged combinations of converters. Furthermore, the filtering represented by the module 28 in FIG. 3 has to be done at the output of the interphase induction coil. In other words, the addition of an interphase induction coil between the converters means implementing a centralized, and non-distributed, filtering system in each of the converters. The use of an interphase induction coil and therefore a centralized filtering, for each envisaged combination of converters, limits the modularity of the architecture. It is only possible to switch over statically, between predefined configurations, imposed by the structure of the interphase induction coils. The number and the weight of the interphase induction coils may become significant and in practice limits the modularity and the reconfigurability to a small number of configurations.

To sum up, the implementation of a modular electrical power supply architecture capable of distributing the conversion capacity according to the instantaneous electrical power requirements of the different electrical loads offers many benefits. However, it has been found that the parallel association of converters is in practice difficult because of the recirculation currents generated between the converters. This problem still has to be resolved because the immediate solution consisting in arranging an interphase induction coil between parallel-associated converters does not allow for a sufficient modularity. The aim of the invention is a modular and reconfigurable power conversion device that mitigates these difficulties.

To this end, the subject of the invention is a device for powering a plurality of loads from an electrical energy supply network, comprising a number of converters, supplied with electrical energy by the network, ensuring the conversion and supply of electrical energy for at least one load. The device comprises a control member configured to associate a number of converters in parallel to power at least one load, in response to a power requirement from the at least one load. Each of the converters comprises distributed means for limiting recirculation currents generated by the parallel association of a number of converters.

Advantageously, the distributed means of each of the converters are configured to generate a high zero-sequence impedance opposing the creation of recirculation current between the parallel-associated converters.

Advantageously, each of the converters delivers electrical energy to the at least one load in N1 phases. The distributed means of each of the converters comprise a zero-sequence transformer coupling the N1 phases, configured to generate a high zero-sequence impedance making it possible to oppose, for each phase, the creation of high-frequency recirculation current between the converters.

Advantageously, each of the converters delivers electrical energy to the at least one load in N1 phases, and the distributed means of each of the converters comprise, for each of the N1 phases, a differential mode inductor, configured to generate a high zero-sequence impedance making it possible to oppose, for each phase, the creation of high-frequency recirculation current between the converters.

Advantageously, each of the converters comprises filtering means associated with the transformer of each of the N1 phases.

Advantageously, each of the converters delivers three-phase alternating electrical energy to the at least one load.

Advantageously, each of the converters is supplied with electrical energy by the supply network in N2 phases, and the distributed means of each of the converters comprise a transformer coupling the N2 phases, configured to generate a zero-sequence impedance making it possible to oppose, for each phase, the creation of high-frequency recirculation current between the converters.

Advantageously, each of the converters comprises filtering means associated with the transformer coupling the N2 phases.

Advantageously, each of the converters is supplied with electrical energy by a DC electrical network.

Advantageously, the distributed means of each of the converters comprise a zero-sequence regulator configured to control the common-mode voltage of each of the converters so as to cancel the common-mode current of the N1 phases, making it possible to oppose the creation of low-frequency recirculation current between the converters.

Advantageously, the distributed means of each of the converters are configured to cancel common-mode voltage differences between the parallel-associated converters.

Advantageously, the converters deliver energy to the at least one load in N1 phases, and the distributed means of each of the converters comprise a conversion element complementing the conversion means in N1 phases and a filtering element, allowing for an active filtering of common-mode voltage in each of the converters (16).

The invention will be better understood and other advantages will become apparent on reading the detailed description of the embodiments given by way of example in the following figures.

FIG. 1, already presented, represents an exemplary modular and reconfigurable electrical power supply architecture envisaged in the known prior art,

FIG. 2, already presented, illustrates the principle of the interleaving between two parallel-associated converters,

FIG. 3, already presented, illustrates the principle of the use of an interphase induction coil for the parallel association of two converters,

FIG. 4 illustrates the principle of the generation of recirculation currents linked to the parallel association of converters,

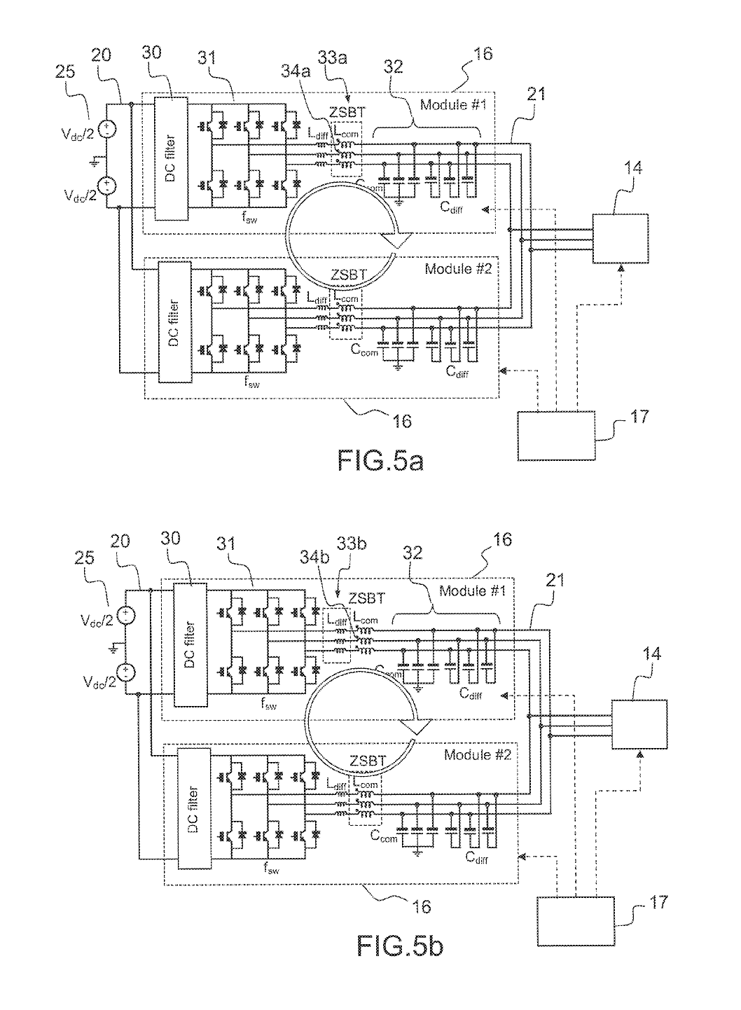

FIGS. 5a and 5b represent two embodiments of an electrical power supply device comprising means for limiting high-frequency recirculation currents,

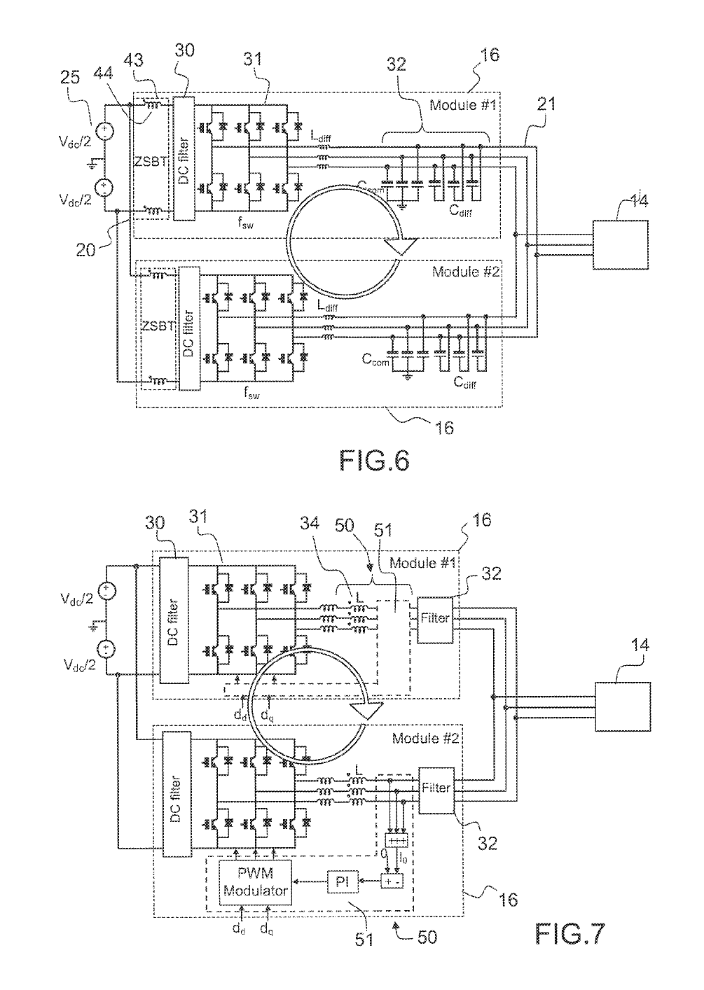

FIG. 6 represents a third embodiment of an electrical power supply device comprising means for limiting high-frequency recirculation currents,

FIG. 7 represents a fourth embodiment of an electrical power supply device comprising complementary means for limiting low-frequency recirculation currents,

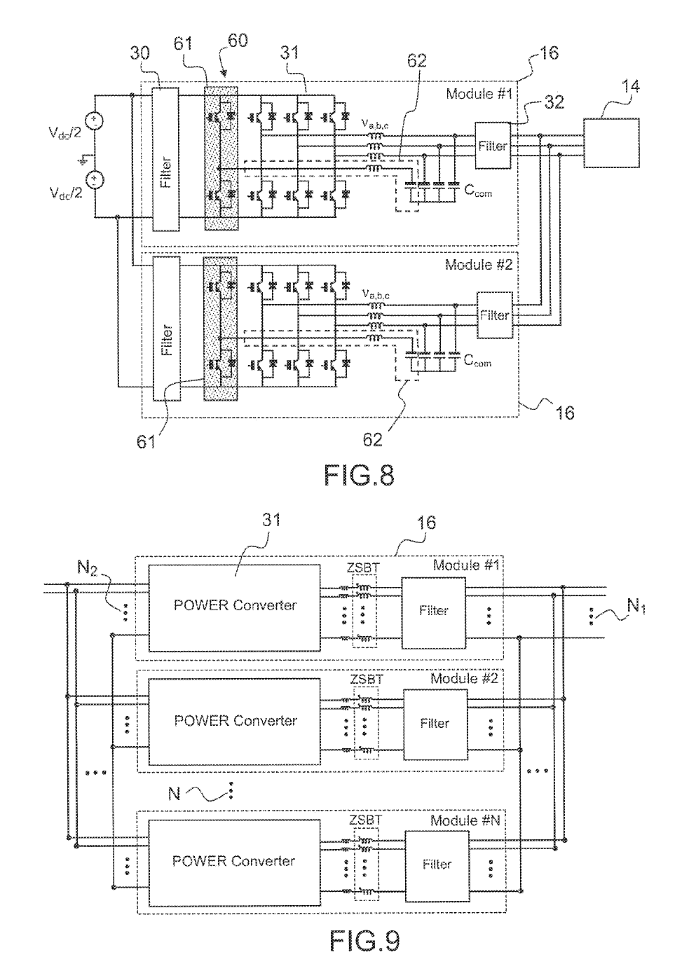

FIG. 8 represents a fifth embodiment of an electrical power supply device comprising means for cancelling common-mode voltage differences,

FIG. 9 represents the parallel association of N converters by means of an electrical power supply device according to the first embodiment,

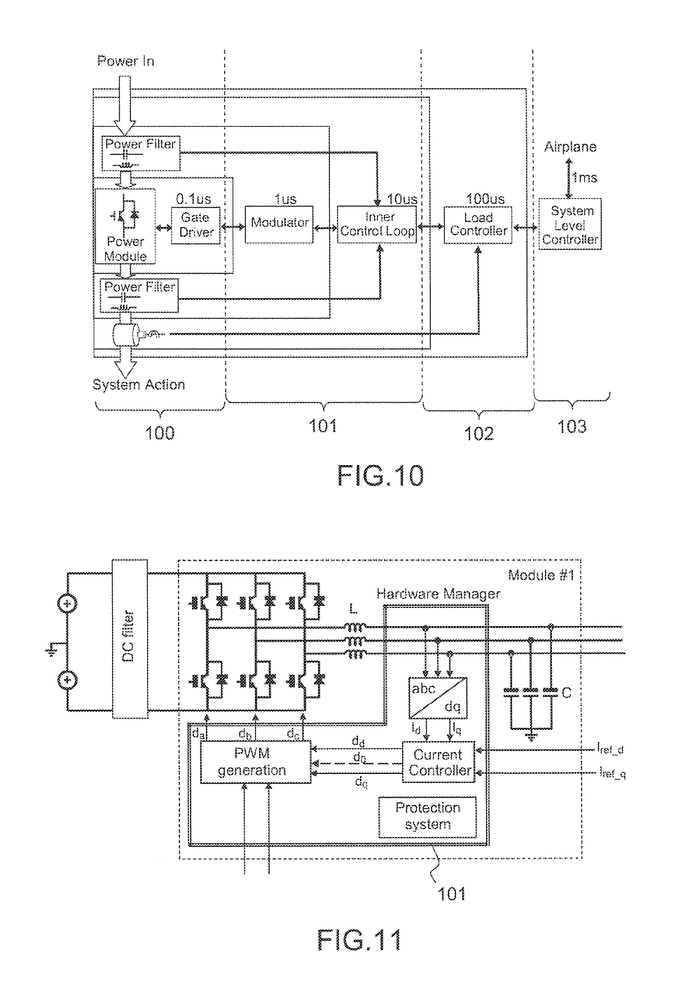

FIG. 10 represents the functional architecture of a control member that can be implemented in the power supply device,

FIG. 11 represents an embodiment of a low-level driving module of the control member,

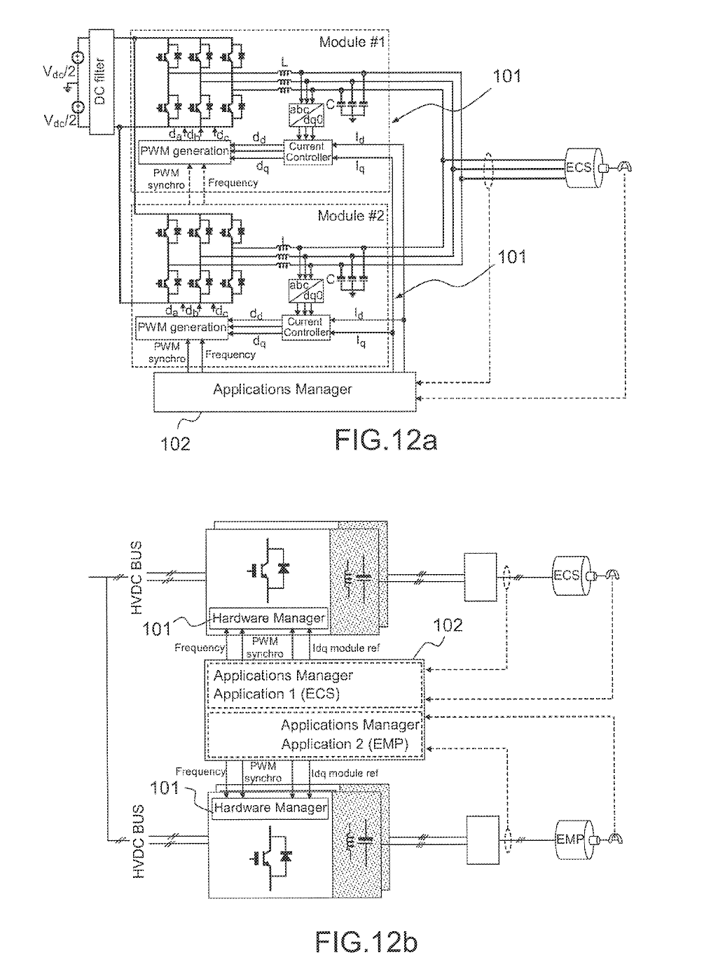

FIGS. 12a and 12b represent an embodiment of an intermediate driving module of the control member,

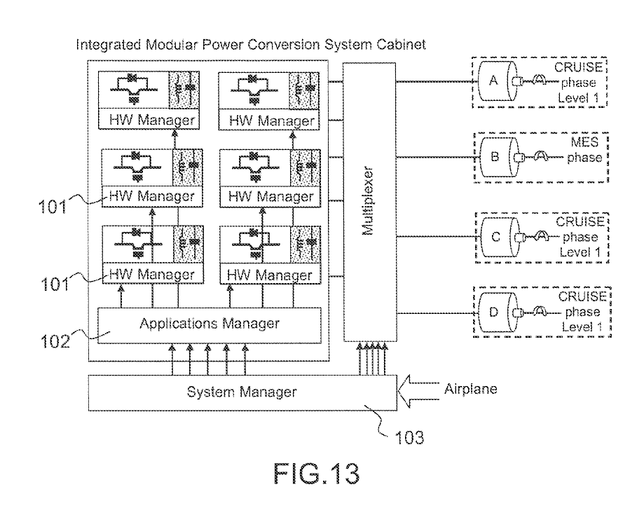

FIG. 13 represents an embodiment of a system driving module of the control member,

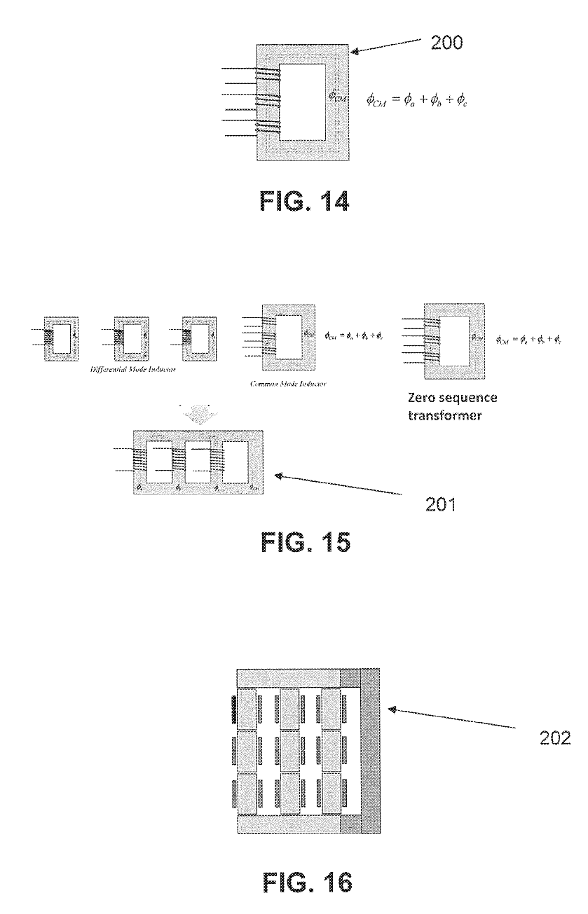

FIG. 14 represents a common-mode transformer with a three-leg circuit,

FIG. 15 represents a compact and single-piece magnetic structure incorporating the zero-sequence transformer components with the common-mode and differential-mode filtering for a converter of inverter/rectifier type,

FIG. 16 represents an exemplary implementation of a compact single-piece magnetic assembly combining magnetic elements necessary for the common-mode and differential-mode filtering for a high-power converter of three-phase inverter/rectifier type.

For clarity, the same elements will bear the same references in the various figures.

FIGS. 4 to 8 describe a number of embodiments of the invention in the most commonplace case of a power supply for the converters 16 by a DC power supply network. The loads 14 are powered by three-phase alternating voltages. In other words, for each of the converters 16, the input 20 comprises two polarities and the output 21 comprises three phases. This choice corresponds to the most widespread case in the aeronautical field. This choice is not however limiting on the present invention. Implementing the invention is also envisaged in different configurations, in terms of current/voltage type and in terms of number of phases, both at the input and at the output of the converters. In this respect, FIGS. 9 and 10 describe the case of parallel-associated converters for powering loads with N1 phases from an electrical energy supply network with N2 phases.

FIG. 4 illustrates the principle of the generation of recirculation currents linked to the association of converters in parallel. The parallel connection and/or the interleaving of a number of converters is likely to generate two types of recirculation currents:
high-frequency recirculation currents, generated by the interaction of the switchings of the different converters, and
low-frequency recirculation currents, due to differences in the control parameters of the different converters.

This phenomenon can be modelled by means of a modelling said to be by “switching functions” represented in FIG. 4. In this case where two converters are associated in parallel, the modelling shows that the recirculation current is a common-mode current, where, in each converter, the sum of the phase currents, iₐ+i_{b}+i_{c}, is not zero but equal to a current i₀ circulating between the two converters. The current i₀ is generated because of the common-mode voltage deviations between the two converters in each switching period of the converter.

To limit the recirculation currents, a first theoretical approach is to create a strong zero-sequence impedance between the converters. This high impedance makes it possible to limit the time-related current trend di/dt resulting from the different common-mode voltages of the converters. This approach can for example be implemented by adding an interphase induction coil between converters as described previously. The implementation of an interphase induction coil between each phase of the converters makes it possible to force the pairs of phase currents (iₐ, iₐ′), (i_{b}, i_{b}′) and (i_{c}, i_{c}′) to values close to zero. This amounts to creating a strong zero-sequence impedance which opposes the creation of a current i₀ between converters. It has however been possible to specify the drawbacks in terms of modularity of this solution with an interphase induction coil external to the converters.

A second theoretical approach consists in cancelling the common-mode voltage differences between the parallel-connected converters. As will be described through the following figures, the device according to the invention makes it possible to limit the circulation currents by means of the first and/or the second theoretical approach, while overcoming the limitations of the existing solutions.

FIG. 5a represents a first embodiment of an electrical power supply device comprising means for limiting high-frequency recirculation currents. In this example, two converters 16, supplied with electrical energy by a same DC network 25, are assigned, by a control member 17, to a load 14. The two converters 16 ensure the conversion and the powering of the load 14 with three-phase alternating voltage. Each converter 16 comprises, between an input 20 and an output 21, means 30 for filtering the energy supplied by the network 25, DC/AC conversion means 31, and means 32 for filtering the alternating signals generated by the conversion means 31. The filtering means 30 and 32 and the conversion means 31 are conventional components well known to those skilled in the art. Their operation is not described in detail here.

Each of the converters 16 also comprises distributed means 33a configured to generate a high zero-sequence impedance opposing the creation of recirculation current between the parallel-associated converters. In this example, the distributed means 33a comprise a zero-sequence transformer 34a linking the conversion means 31 to the filter means 32. In each converter, and independently of the other converters, the zero-sequence transformer 34a couples the three phases of the converter by forcing the sum iₐ+i_{b}+i_{c}=i₀ of each converter to values close to zero. At the system level, this corresponds to generating a high zero-sequence impedance, making it possible to oppose the creation of high-frequency recirculation current between the converters.

The zero-sequence transformers 34a, also called zero-sequence blocking transformers, can be implemented by using a magnetic structure of common-mode inductor type.

The high zero-sequence impedance is generated by using a magnetic body 200 simultaneously coupling the three output phases of each power module, as represented in FIG. 14. This coupling is governed by the magnetic equation FluxA+FluxB+FluxC=Lseq_zero*(Ia+Ib+Ic). The parameter Lseq_zero is determined by the physical geometry of the magnetic body and the number of turns of the windings. The objective is, by design of the geometry and of the number of turns of the windings, to maximize Lseq_zero in order to minimize the recirculation currents.

The magnetic core can be produced, for example, from a toroid type core with three windings. It is also possible to produce the common-mode transformer with a three-leg circuit in which the three windings are positioned on the central leg. Finally, as illustrated in FIG. 14, a two-leg circuit can be used with the three windings positioned on one leg.

Additionally, the application of magnetic integration techniques makes it possible to determine a compact and single-piece magnetic structure 201 incorporating the zero-sequence transformer components with the common-mode and differential-mode filtering for a converter of inverter/rectifier type. The proposed solution makes it possible to incorporate the three differential-mode inductors and the common-mode inductor and the zero-sequence transformers in a compact single-piece magnetic structure comprising four legs and three windings. This solution makes it possible to share the magnetic core and the windings between the differential-mode inductors and the common-mode inductor, as represented in FIG. 15.

The incorporation of all the necessary elements for the zero-sequence transformers and the differential-mode filtering in a single-piece magnetic assembly makes it possible to optimize the weight and volume by sharing the magnetic core between the three inductors. Furthermore, the incorporation of a single-piece assembly also makes it possible to improve the weight and the volume through the reduction of the accessories necessary for the packaging and the interconnection of the magnetic elements.

The single-piece magnetic assembly is made up of a magnetic core with four legs. Three of the legs with their associated windings act as differential inductors for the phase concerned. A fourth leg without winding acts as common-mode inductor. The single-piece magnetic assembly is identical in terms of magnetic equation to the zero-sequence transformer, to the three single-phase inductors and the common-mode inductor as illustrated by the modellings by reluctance circuit of FIG. 15.

FIG. 16 illustrates an exemplary implementation of a compact single-piece magnetic assembly 202 combining the magnetic elements necessary to the common-mode and differential-mode filtering for a high-power converter of three-phase inverter/rectifier type. An implementation of the single-piece compact magnetic element may use, for the differential legs, a high induction material with a discrete airgap distributed so as to minimize the high-frequency losses. It is also possible to implement a distributed airgap by adapting the material used. The common-mode inductor is implemented by the addition of a fourth leg to the differential three-phase block. The common-mode leg can be implemented using materials with high magnetic permeability such as nanocrystalline materials.

In other words, this first embodiment relies on the first theoretical approach to reducing the recirculation currents described in the context of FIG. 4. The zero-sequence transformer 34a generates a zero-sequence impedance by coupling, for each converter, each of the phases through the magnetic body. The impedance generated opposes the creation of a recirculation mode current by the common-mode voltage difference between the converters. These transformers are dimensioned similarly to a common-mode filtering induction coil. Simple and controlled technological solutions, such as toroidal or E-shaped magnetic cores made of nanocrystalline materials, can be implemented to obtain strong impedance values that make it possible to limit the recirculation currents to relatively low values.

FIG. 5b represents a second embodiment of an electrical power supply device comprising means for limiting high-frequency recirculation currents. As for the preceding embodiment, two converters 16, supplied with electrical energy by a same DC network 25, are assigned, by a control member 17, to a load 14. The two converters 16 ensure the conversion and the powering of the load 14 with three-phase alternating voltage. Each converter 16 comprises, between an input 20 and an output 21, means 30 for filtering the energy supplied by the network 25, DC/AC conversion means 31, and means 32 for filtering the alternating signals generated by the conversion means 31.

Each of the converters also comprises distributed means 33b configured to generate a high zero-sequence impedance opposing the creation of recirculation current between the parallel-associated converters. In this example, the distributed means 33b comprise, for each of the phases, a differential-mode inductor, or, in other words, a three-phase differential inductor 34b linking the conversion means 31 to the filtering means 32. The differential-mode inductors are perceived by the differential component and the common-mode component of the current. Based on their value, the differential-mode inductors in each converter reduce the sum iₐ+i_{b}+i_{c}=i₀ of each converter to values close to zero. At the system level, they contribute to generating a high zero-sequence impedance, making it possible to oppose the creation of high-frequency recirculation current between the converters.

Thus, this second embodiment relies also on the first theoretical approach to reducing the recirculation currents described in the context of FIG. 4. The differential-mode inductors generate a zero-sequence impedance. These inductors are dimensioned in a manner similar to a differential-mode filtering induction coil. Their dimensioning can be the subject of optimization at the system level. A strong differential-mode inductance value in each module makes it possible to reduce the common-mode current to a low value. However, a strong differential-mode inductance value is detrimental in terms of weight and volume, despite the new magnetic materials. Conversely, a lower differential-mode inductance value increases the value of the recirculation current and therefore the ripple and the peak currents in the phases of the conversion means. It is also known that a high current in the switches of the conversion means is damaging to their operation. Thus, the optimization of the differential-mode inductance value results from a trade-off between the value of the peak currents per phase, the recirculation currents, and the definition of the switches. Typically, an optimized differential-mode inductance value makes it possible to obtain a ripple compatible with the definition of the switches, by minimizing the switching losses by producing a soft switching, without switching loss on priming for the switches and without switching loss for the diodes on blocking.

It is interesting to note that, to observe the EMI specifications, it is necessary to implement, in the converters 16, a differential-mode filtering. The differential-mode filtering is equivalent to differential-mode induction coils. An additional optimization is therefore to integrate, in each of the converters, differential-mode induction coils to limit the recirculation current with the differential-mode induction coils necessary for compliance with the EMI specifications. This makes it possible to couple the means for limiting the recirculation currents and the differential-mode inductors necessary to the EMI requirements by means of a single magnetic component. In other words, an appropriate dimensioning of the differential-mode inductors makes it possible to incorporate the function of the means for limiting the recirculation currents, advantageously making it possible to limit the weight of the overall filtering, without resulting in the implementation of additional components.

FIG. 6 represents a second embodiment of an electrical power supply device according to the invention. As previously, two converters 16, powered by the DC network 25, are assigned by a control member (not represented in this figure) to a load 14. Each converter 16 comprises, between an input 20 and an output 21, means 30 for filtering the energy supplied by the network 25, conversion means 31, and means 32 for filtering the alternating signals generated by the conversion means 31.

Each of the converters 16 also comprises distributed means 43 configured to generate a high zero-sequence impedance opposing the creation of recirculation current between the parallel-associated converters. In this example, the distributed means 43 are arranged at the input 20 of the converters 16 and comprise, for each polarity of the DC network 25, a transformer 44 linking the input 20 to the conversion means 31.

In other words, this second embodiment implements a zero-sequence blocking mode transformer in each converter. Each transformer creates a zero-sequence impedance by coupling the two input polarities of each converter through the magnetic body of the transformer. As previously, the impedance generated opposes the creation of a recirculation mode current by the common-mode voltage difference between the converters. The technological solutions already mentioned, such as toroidal or E-shaped magnetic cores, made of materials of nanocrystalline type, can advantageously be implemented.

It is interesting to note that, to observe the EMI specifications, the converter system needs to implement a common-mode filtering. Typically, this common-mode filtering corresponds to a common-mode induction coil coupling the three output phases of the converters. An additional optimization is therefore to integrate, in each of the modules, zero-sequence blocking transformers with the common-mode inductor necessary for the filterings of the common-mode switching noise. This makes it possible to implement the zero-sequence blocking transformer and the common-mode inductor in a single magnetic element. The appropriate dimensioning of the zero-sequence blocking transformers therefore makes it possible to incorporate the common-mode filtering function thus minimizing the weight of the overall filtering. The incorporation in each of the modules of these recirculation current blocking devices and of the common-mode filtering makes it possible to not add any additional element for the parallel connecting of the modules.

FIG. 7 represents a fourth embodiment of an electrical power supply device comprising complementary means for limiting low-frequency recirculation currents. The three first embodiments described respectively in FIGS. 5a, 5b and 6 implement distributed means in each of the converters capable of limiting the high-frequency recirculation currents. The fourth embodiment described by FIG. 7 comprises distributed means similar to the first embodiment, comprising a zero-sequence transformer 34 making it possible to limit the high-frequency recirculation currents. The aim of the fourth embodiment is to also limit the low-frequency recirculation currents. For that, it associates, with the zero-sequence blocking transformers limiting the high-frequency recirculation currents, a zero-sequence regulator to limit the low-frequency recirculation currents. The zero-sequence regulator can be associated with transformers implemented in the input filters or in the output filters. In FIG. 7, each converter 16 comprises means 30 for filtering the energy supplied by the DC network 25, conversion means 31, and means 32 for filtering the alternating signals generated by the conversion means 31. Each converter also comprises distributed means 50 configured to generate a high zero-sequence impedance opposing the creation of recirculation current between the parallel-associated converters. The distributed means 50 comprise, on the one hand, a zero-sequence transformer linking the conversion means 31 to the filtering means 32, and, on the other hand, a zero-sequence regulator 51. The zero-sequence regulator 51 comprises means for measuring the phase currents iₐ, i_{b} and i_{c} at the output of the transformers 34, calculating the common-mode current iₐ+i_{b}+i_{c}, and driving the conversion means 31 with, for regulation setpoint, a zero common-mode current. In other words, the regulator 51 makes it possible to reduce the low-frequency recirculation currents by locking the low-frequency component of the recirculation current at zero by controlling the common-mode voltage by the PWM setpoints of the conversion elements 31. One possible control variable for the common-mode voltage is the distribution of the zero vector of the PWM setpoints between the vector (1,1,1) and the vector (0,0,0). The time of the vector (1,1,1) can be equal to the time of the vector (0,0,0). For a given length of the zero vector, the zero-sequence controller can act on the distribution between the vector (1,1,1) and the vector (0,0,0) and lock the common-mode voltage at the output of the converter to control the low-frequency recirculation current to zero. Each converter thus independently controls its recirculation current, making it possible, at the level of the power supply device, to cancel all of the recirculation currents without using any common corrector. The principle of this zero-sequence regulator distributed in each converter makes it possible to cancel the low-frequency recirculation currents. This regulator can be implemented in different ways depending on the applications concerned and the topologies of the converters.

FIG. 8 represents a fifth embodiment of an electrical power supply device according to the invention. Unlike the preceding three, this fifth embodiment relies on the second theoretical approach to reducing the recirculation currents described in the context of FIG. 4. This embodiment is based on the cancelling of the common-mode voltage of each of the converters; or, to put it another way, on active common-mode voltage filtering means. For that, each converter comprises an additional switching arm.

As for the preceding figures, each converter 16 comprises means 30 for filtering the energy supplied by the DC network 25, conversion means 31, and means 32 for filtering the three-phase alternating signals generated by the conversion means 31. Each converter further comprises distributed means 60 for limiting the recirculation currents generated by the parallel association of a number of converters. The distributed means 60 comprise an additional conversion element 61, incorporated in the conversion means 31, and a filtering element 62. These distributed means 60 thus constitute an additional switching arm, associated with the three switching arms of each of the phases. The distributed means 60 are driven, in particular the duty cycle opening control, or PWM, of the conversion element 61, so as to cancel the common-mode voltage of the three phases. In other words, the fourth arm makes it possible, by suitable PWM driving, to control the common-mode voltage of each converter. It is possible to lock the common-mode voltage of each converter, with, for regulation setpoint, a zero recirculation current.

FIG. 8 describes the principle of the active filtering of the common-mode voltage in the case of an electrical conversion into three phases. This example is not limiting; more broadly, distributed means 60 are envisaged comprising an additional conversion element incorporated in means for electrical conversion into N1 phases.

FIG. 9 represents the parallel association of N converters by means of an electrical power supply device according to the invention. The most commonplace case of converters powered by a DC network and delivering three-phase alternating voltages does not constitute a limitation on the present invention. As represented in FIG. 9, the power supply device can comprise N converters, powered by an electrical energy network in N2 phases, ensuring the conversion and the powering of loads in N1 phases. Various types of conversion means 31 can be implemented (AC/AC, DC/AC, AC/DC, DC/DC).

FIG. 10 represents the functional architecture of a control member implemented in the power supply device. It has been specified that the power supply device according to the invention comprised a control member 17 capable of allocating one or more converters to a load in real time. There now follows a description of a preferred embodiment of this control member responsible for allocating the converters and for driving them. The control member envisaged by the present invention ensures the driving of all of the power supply device by various functions. It manages in particular the parallel association of the converters, the driving of load control algorithms, the interleaving between the converters, or even the driving of the control algorithm specific to the converters independently of the loads.

The control member can be split into a number of modules according to functional and time-related criteria. Among the functional criteria, the architecture of the control member retained takes account in particular of the type of conversion performed, of the internal structure of the converter, of the load control algorithm, or of the possible reconfigurations of the power supply device. Among the time-related criteria, account is taken of the time constants of the protection functions, of the electromechanical time constants, of the bandwidths of the control algorithms, and of the sampling and switching frequencies.

As represented in FIG. 10, a control member 17 is envisaged comprising, in addition to a power stage 100, three driving modules: a low-level driving module 101, an intermediate driving module 102 and a system driving module 103. The principle and embodiments of these driving modules are described in the subsequent figures.

FIG. 11 represents an embodiment of a low-level driving module of the control member. This module 101 is responsible for fast tasks dedicated to the electrical energy conversion, and associated protection tasks. A low-level driving module is associated with each converter of the device. It is preferentially implemented in an electronic device incorporated in the converter, for example with the power stage. Alternatively, the low-level driving modules of the converters can be combined in a central electronic device. The low-level driving module 101 associated with a converter is independent of the electrical load.

The close control is designated to assume the rapid tasks and tasks oriented toward the energy conversion and the associated protection. This control is independent of the load and of its dedicated control algorithms. The close control forms an integral part of the conversion elements making these elements intelligent and capable of interfacing with a higher level application layer. The close control also manages the inter- and intra-module interactions due to the interleaving and to the parallel connection of these modules. The close control includes the low-frequency recirculation current control elements with an incorporated zero-sequence current controller acting on the PWM control to keep the low-frequency recirculation current at zero.

The low-level driving module 101 comprises, for each of the converters, means for regulating the currents I_{d}, I_{q} and I₀. The control of current i₀ ensures the locking of the recirculation current to zero by acting on the PWM control of the converter. The control of the currents I_{d} and I_{q} ensures the locking of the output currents of each of the converters on setpoint values transmitted by the intermediate driving module in a master/slave relationship. This particular configuration allows for a balancing of the currents between the parallel-associated converters.

In the case where the converters comprise means for limiting low-frequency recirculation currents, by means of a zero-sequence regulator 51 described by FIG. 7, the low-level driving module 101 ensures the PWM control of the regulator. In the case where the converters comprise active common-mode voltage filtering means 60, by means of an additional conversion arm 61 described by FIG. 8, the low-level driving module 101 ensures the control of the additional conversion arm.

The low-level driving is specific to each of the converters, and is independent of the intermediate driving and system driving parameters.

As represented in FIG. 11, the close control is responsible for the control tasks dedicated to the conversion such as, for example:
PWM modulation and generation
Gate drivers
Current mode control
Overcurrent and over-temperature protection
Control of the low-frequency recirculation currents
Control of the high-frequency recirculation currents for active solution
etc.

The incorporation of this control in the conversion elements renders them generic and decouples the tasks linked to the conversion from the tasks linked to the application or system control. This emphasizes the possibility of creating a modular system and an open platform based on generic conversion modules independent of the applications.

FIGS. 12a and 12b represent an embodiment of an intermediate driving module of the control member. This module 102 is responsible for the tasks dedicated to the control of the electrical loads 14, the tasks of interleaving and parallel connecting the converters. The intermediate driving module 102 controls the low-level driving modules 101 of the converters in a master/slave relationship. This relationship is, for example, illustrated by FIG. 12a which represents an intermediate driving module ensuring the control of the low-level driving modules 101 of two converters connected in parallel to power an electrical load 14. The intermediate driving module 102 transmits to the converters driving setpoint values matched to the allocation between the converters and the loads. It transmits, for example, setpoints relating to the type of conversion to be performed, the switching frequency, the type of PWM or even setpoints relating to the interleaving and the parallel-connecting in real time.

The intermediate driving module is independent of the energy conversion tasks taken over by the low-level driving modules. It simply ensures the control thereof. By way of example, the control algorithms without compressor, hydraulic pump or starter sensor, or even the bus regulation (for example of 400 Hz CF or 28 Vdc type) or battery charging algorithms will be implemented in the intermediate driving module.

The application brain is completely independent and decoupled from the conversion and energy conditioning tasks assumed by the close controls.

As represented in FIG. 12b, the intermediate driving module is configured to ensure the simultaneous control of a number of electrical loads. For each of the electrical loads, an intermediate-level control ensures the control of the low-level driving modules of each of the converters connected in parallel to power the load.

The present invention also envisages implementing a number of intermediate driving modules to ensure a redundancy of the associated control. The intermediate driving module can be implemented in an independent electronic module with redundancy.

FIG. 13 represents an embodiment of a system driving module of the control member. This module 103 is responsible for supervision and monitoring tasks. The system driving module 103 ensures the real-time allocation of converters to the electrical loads. It then coordinates the control of the intermediate driving modules 102 and defines their setpoint parameters. The system driving module 103 is interfaced with the aircraft, and reconfigures the electrical power supply device according to information transmitted by the aircraft. It also manages the protection devices and the failures of the intermediate driving modules 102.

The implementation of a number of system driving modules is envisaged to ensure a redundancy of the associated control. The system driving module can be implemented in an independent electronic module with redundancy. It can also be implemented in an existing redundant control member, such as, for example, the BPCU or any other redundant control member present in the aircraft.

This particular functional architecture of the control member is advantageous because it allows for a modular electrical architecture and an open development platform. The low-level tasks are masked and decoupled from the tasks of higher hierarchical level. The system is entirely modular and reconfigurable based on converters independent of the electrical loads and of the electrical energy supply network. This configuration makes it possible to optimize the electrical power installed in the aircraft by the real time allocation of the sharing of the conversion resources between the N loads. This configuration also makes it possible to optimize the filtering included in the converters by their interleaving at the system level, on the source side and on the load side.

This modular architecture constitutes an open development platform, allowing for the integration of elements from different industrial partners without any particular difficulty in interfacing with the rest of the device.

The proposed architecture is a generic solution and a modular platform that makes it possible to incorporate multiple functions sharing the same conversion resources. This architecture combines multiple functions in a power conversion centre making it possible to reduce the weight and the costs by eliminating the need for converters dedicated to the different applications. FIG. 13 illustrates a cabinet incorporating four applications (A, B, C, D) in the application brain.

The proposed architecture is based on an open architecture allowing for the integration of third-party applications without intellectual property or interfacing difficulties. It allows for the incorporation of functions developed by different suppliers within the same cabinet.

The distributed and partitioned control architecture, combined with high computing integrity, allows for safe operation of different functions in the system with an open architecture. Each partner receives a standard power building block, a set of development tools and a set of development rules for the development of their control algorithms and software code. When the partner finishes developing the control algorithm and the software, the software is uploaded into the application brain of the cabinet without any compatibility or intellectual property problems.

1. A device for powering a plurality of loads from an electrical energy supply network, comprising a number of converters, supplied with electrical energy by the network, ensuring the conversion and the supply of electrical energy for at least one load,
further comprising a control member configured to associate a number of converters in parallel to power at least one load, in response to a power requirement from at least one load,
wherein each of the converters comprises distributed means for limiting recirculation currents generated by the parallel association of a number of converters.

2. The device according to claim 1, in which the distributed means of each of the converters are configured to generate a high zero-sequence impedance opposing the creation of recirculation current between the parallel-associated converters.

3. The device according to claim 2, in which each of the converters delivers electrical energy to the at least one load in N1 phases, and in which the distributed means of each of the converters comprise a zero-sequence transformer coupling the N1 phases, configured to generate a high zero-sequence impedance making it possible to oppose, for each phase, the creation of high-frequency recirculation current between the converters.

4. The device according to claim 2, in which each of the converters delivers electrical energy to the at least one load in N1 phases, and in which the distributed means of each of the converters comprise, for each of the N1 phases, a differential mode inductor, configured to generate a high zero-sequence impedance making it possible to oppose, for each phase, the creation of high-frequency recirculation current between the converters.

5. The device according to claim 3, in which each of the converters comprises filtering means associated with the transformer of each of the N1 phases.

6. The device according to claim 3, in which each of the converters delivers three-phase alternating electrical energy to the at least one load.

7. The device according to claim 2, in which each of the converters is supplied with electrical energy by the supply network in N2 phases, and in which the distributed means of each of the converters comprise a transformer coupling the N2 phases, configured to generate a zero-sequence impedance making it possible to oppose, for each phase, the creation of high-frequency recirculation current between the converters.

8. The device according to claim 7, in which each of the converters comprises filtering means associated with the transformer coupling the N2 phases.

9. The device according to claim 7, in which each of the converters is supplied with electrical energy by a DC electrical network.

10. The device according to claim 3, in which the distributed means of each of the converters comprise a zero-sequence regulator configured to control the common-mode voltage of each of the converters so as to cancel the common-mode current of the N1 phases, making it possible to oppose the creation of low-frequency recirculation current between the converters.

11. The device according to claim 1, in which the distributed means of each of the converters are configured to cancel common-mode voltage differences between the parallel-associated converters.

12. The device according to claim 11, in which the converters deliver energy to the at least one load in N1 phases, and in which the distributed means of each of the converters comprise a conversion element complementing the conversion means in N1 phases and a filtering element, allowing for an active filtering of common-mode voltage in each of the converters.
